(19) United States
(12) Patent Application Publication
(10) Pub. No.: US 2015/0009106 A1
(43) Pub. Date: Jan. 8, 2015

(54) DISPLAY APPARATUS

(71) Applicant: Samsung Display Co., Ltd., Yongin-city (KR)

(72) Inventors: June-Woo LEE, Yongin-city (KR); Dong-Gyu Kim, Yongin-city (KR); Beohm-Rock Choi, Yongin-city (KR); Jae-Ho Lee, Yongin-city (KR); Myung-Koo Hur, Yongin-city (KR)

(73) Assignee: Samsung Display Co., Ltd., Yongin-city (KR)

(21) Appl. No.: 14/226,219

(22) Filed: Mar. 26, 2014

(30) Foreign Application Priority Data
Jul. 4, 2013 (KR) 10-2013-0078437

(51) Int. Cl. G09G 3/32

(52) U.S. Cl. CPC G09G 3/3208
USPC 345/77

(57) ABSTRACT

A display apparatus including: a unit pixel including sub-pixels, each sub-pixel including an emission area including a light emitting element and a circuit area including a switching transistor to control the light emitting element; a scan line extending in a first direction and connected to the unit pixel; a branch line extending from the scan line in a second direction crossing the first direction, and connected to the each of the sub-pixels; and data lines extending in the second direction and respectively connected to the sub-pixels.

### CROSS REFERENCE TO RELATED APPLICATION

This application claims priority from and the benefit of Korean Patent Application No. 10-2013-0078437, filed on Jul. 4, 2013, which is hereby incorporated by reference for all purposes as if fully set forth herein.

### BACKGROUND

1. Field

One or more embodiments of the present invention relate to a display apparatus.

2. Discussion of the Background

A display apparatus includes pixels in its display area, and when each of the pixels includes an organic light-emitting device, the display apparatus may be referred to as an organic light-emitting display apparatus. The organic light-emitting display apparatus includes a is pixel circuit that drives the organic light-emitting device. The pixel circuit is connected to a data line that receives a data signal, and a scan line that receives a scan signal. That is, the data line and the scan line are independently connected to each of the pixels that are included in the display apparatus.

Since scan lines are arranged to correspond to a number of columns or lines of pixels that are disposed in a display region of a display apparatus, an ability to improve an aperture ratio of the display apparatus is limited. Also, as the number of pixels is increased to realize high-definition, the number of the scan lines is increased, which also results in an increase in the defect rate of wiring in the display apparatus.

### BRIEF SUMMARY OF THE INVENTION

One or more embodiments of the present invention include a display apparatus having a decreased number of scan lines.

Additional aspects will be set forth in part in the description which follows and, in part, will be apparent from the description, or may be learned by practice of the presented embodiments.

According to one or more embodiments of the present invention, a display apparatus includes: a sub-pixel including an emission area and a circuit area, wherein the emission area emits light and the circuit area includes a switching transistor and controls the emission area; a unit pixel formed of a plurality of sub-pixels; a scan line extending in a first direction and corresponding to the unit pixel; a branch line extending from the scan line in a second direction crossing the first direction, and connected to the plurality of the sub-pixels that form the unit pixel; and a plurality of data lines extending in the second direction and connected is to the plurality of the sub-pixels, respectively.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a plane view of a display apparatus according to an exemplary embodiment of the present invention.

FIG. 2 is a circuit diagram illustrating a structure of a sub-pixel included in the display apparatus of FIG. 1.

FIG. 3 is a cross-sectional view illustrating a structure of a portion of a sub-pixel included in the display apparatus of FIG. 1.

FIG. 4A is a magnified view of portion IV of the display apparatus of FIG. 1, and

FIG. 4B is a magnified view and cross-sectional view of portion a-a′, b-b′ and c-c′ of FIG. 4A, to according to an exemplary embodiment of the present invention.

FIG. 5 is a magnified view of portion IV of the display apparatus of FIG. 1, according to another exemplary embodiment of the present invention.

FIG. 6 is a magnified view of portion IV of the display apparatus of FIG. 1, according to another embodiment of the present invention.

### DETAILED DESCRIPTION OF THE ILLUSTRATED EMBODIMENTS

As the invention allows for various changes and numerous embodiments, particular embodiments will be illustrated in the drawings and described in detail in the written description. The effects and characteristics of one or more embodiments of the present invention will be described in detail by explaining exemplary embodiments of the invention with reference to the attached drawings. However, the invention may, however, be embodied in many different forms, and should not be construed as being limited to the embodiments set forth herein.

Hereinafter, the present invention will be described in detail by explaining exemplary embodiments of the invention with reference to the attached drawings. Like reference numerals in the drawings denote like elements, and descriptions thereof are omitted here.

The terms “first” and “second” are used only to distinguish between each component. Throughout the specification, a singular form may include plural forms, unless there is a particular description contrary thereto.

Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are is no intervening elements or layers present.

In the drawings, the thicknesses of layers and regions are exaggerated for clarity. For example, a size and thickness of each of elements in the drawings may be exaggerated, and in this regard, one or more embodiments of the present invention are not limited thereto.

As used herein, the term “and/or” includes any and all combinations of one or more of the associated listed items. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

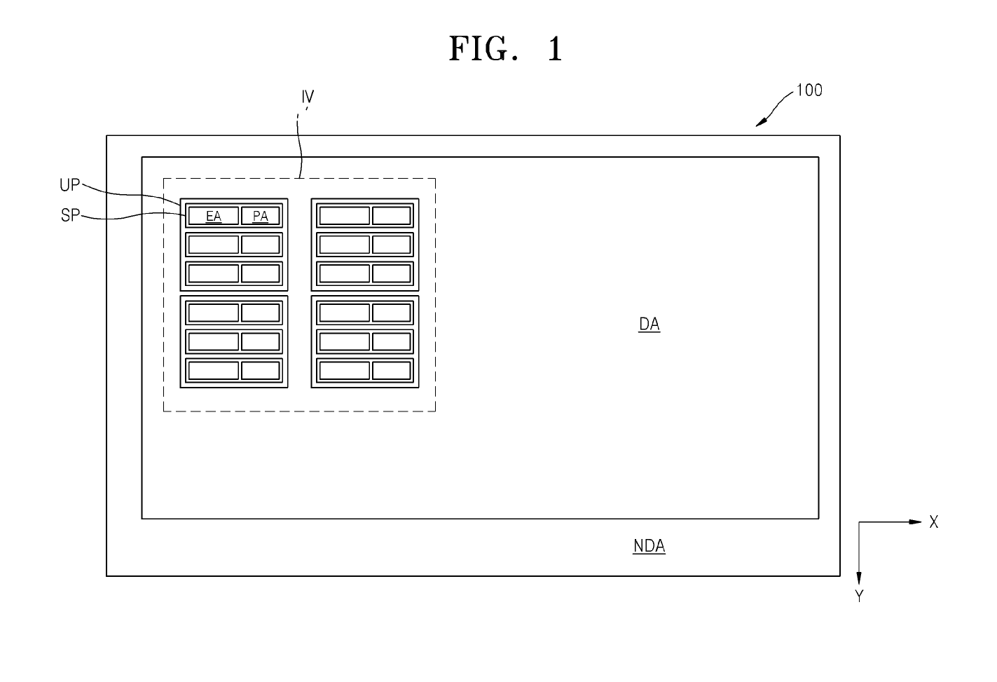

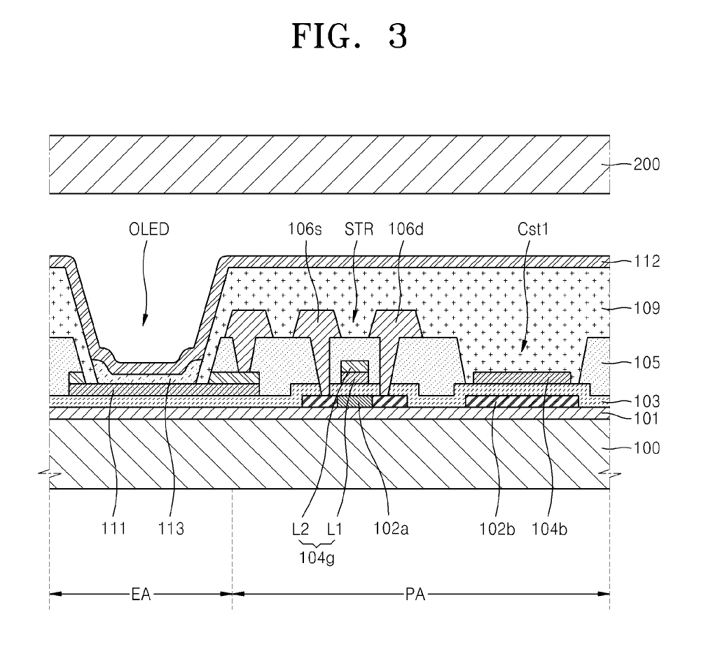

FIG. 1 is a plane view of a display apparatus, according to exemplary embodiments of the present invention. The display apparatus includes a substrate 100 having pixels formed thereon, and an encapsulation member 200 (refer to FIG. 3) to encapsulate the pixels on the substrate 100. FIG. 1 schematically illustrates the substrate 100 having the pixels formed thereon. The substrate 100 includes a display area DA in which the pixels are formed, and a non-display area NDA disposed around the display area DA. The substrate 100 may be formed of various materials, such as a glass material, a metal material, a plastic material, or the like.

The pixels are formed in the display area DA of the substrate 100, and each of the pixels includes an emission area EA and a circuit area PA. Light is emitted from the emission area EA, and a circuit unit for controlling the emission of light from the emission area EA is arranged in the circuit area PA. When the display apparatus is an organic light-emitting display apparatus, an organic light-emitting device is arranged in the emission area EA. The circuit area PA includes two or more thin film transistors (TFTs) and at least one capacitor. At least one of the TFTs that are arranged in the circuit area PA may be directly connected to the organic light-is emitting device. One of the TFTs arranged in the circuit area PA is referred to as switching transistor. The switching transistor is coupled with a scan line and a data line, which are described later. The switching transistor is turned on by a scan signal, so as to transfer a data signal to the capacitor and the rest of the TFTs.

The pixels may be grouped to form a unit pixel UP. Throughout the specification, each of the pixels that form the unit pixel UP is referred to as a sub-pixel SP. The number of sub-pixels SP that form the unit pixel UP may be equal to or greater than 2, and in the present embodiment, three sub-pixels SP form one unit pixel UP. The three sub-pixels SP that form the unit pixel UP may emit light of different colors. For example, the three sub-pixels SP included in the unit pixel UP may respectively emit red light, green light, and blue light. However, in other embodiments, some of the sub-pixels SP that form the unit pixel UP may emit light of the same color, or all of the sub-pixels SP that form the unit pixel UP may emit light of the same color.

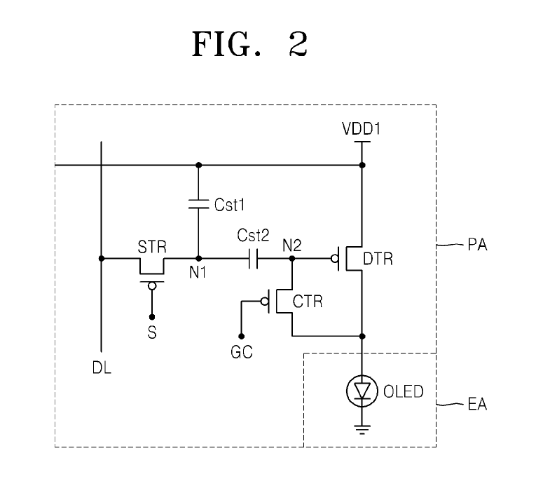

FIG. 2 is a circuit diagram illustrating the structure of a sub-pixel SP included in the display apparatus of FIG. 1. For example, three TFTs (i.e., a switching transistor STR, a driving transistor DTR, and a compensation transistor CTR) and two capacitors (i.e., a first capacitor Cst1 and a second capacitor Cst2) may be included in a circuit area PA of the sub-pixel SP. A scan signal is applied to a gate electrode of the switching transistor STR, a source electrode of the switching transistor STR is connected to a data line DL, and a drain electrode of the switching transistor STR is connected to a first node N1. A gate electrode of the driving transistor DTR is connected to a second node N2, and a source electrode of the driving transistor DTR is connected to a first power voltage line VDD1. A drain electrode of the driving transistor DTR is connected to an organic light-emitting device OLED.

A compensation signal GC is applied to a gate electrode of the compensation transistor CTR, a source electrode of the compensation transistor CTR is connected to the second node N2, and a drain electrode of the compensation transistor CTR is connected to a drain electrode of the driving transistor DTR. An end of the first capacitor Cst1 is connected to the first power voltage line VDD1, and the other end of the first capacitor Cst1 is connected to the first node N1. An end of the second capacitor Cst2 is connected to the first node N1, and the other end of the second capacitor Cst2 is connected to the second node N2. However, the number of the TFTs and the capacitors, and a relation therebetween, which are shown in FIG. 2, may be changed.

The organic light-emitting device OLED is disposed in the emission area EA of the sub-pixel SP. An end of the organic light-emitting device OLED is connected to the driving transistor DTR, and a second power voltage line is applied to the other end of the organic light-emitting device OLED.

FIG. 3 is a cross-sectional view illustrating the structure of a portion of a sub-pixel SP included in the display apparatus of FIG. 1. FIG. 3 only illustrates the switching transistor STR of the TFTs shown in FIG. 2, the first capacitor Cst1, and the organic light-emitting device OLED. Cross-sections of the rest of the TFTs and the second capacitor Cst2 are similar to those of the switching transistor STR and the first capacitor Cst1 shown in FIG. 3, and thus, detailed descriptions thereof are omitted.

A buffer layer 101 that is formed of silicon oxide or silicon nitride is disposed on the substrate 100, so as to planarize a surface of the substrate 100 and/or to prevent impurities from penetrating into a semiconductor layer 102a. The switching transistor STR is formed in the circuit area PA and includes the semiconductor layer 102a, a gate electrode 104g, and is source/drain electrodes 106s and 106d. The semiconductor layer 102a may include amorphous silicon, poly-silicon, or an organic semiconductor material.

The gate electrode 104g may have a multi-layer structure including a first layer L1 that is formed of a transparent conductive material and a second layer L2 that is formed of a low resistive material such as metal. For example, the first layer L1 may be formed of at least one of indium tin oxide (ITO), indium zinc oxide (IZO), zinc oxide (ZnO), indium oxide (M₂O₃), indium gallium oxide (IGO), and aluminum zinc oxide (AZO). The second layer L2 may be formed as a single or multiple layer by using at least one of aluminum (Al), platinum (Pt), palladium (Pd), silver (Ag), magnesium (Mg), gold (Au), nickel (Ni), neodymium (Nd), iridium (Ir), chrome (Cr), lithium (Li), calcium (Ca), molybdenum (Mo), titanium (Ti), tungsten (W), and copper (Cu), in consideration of adhesion with its adjacent layers, surface planarization of a stacked target layer, formability, or the like.

In order to obtain insulation between the semiconductor layer 102a and the gate electrode 104g, a gate insulating layer 103 that is formed of silicon oxide and/or silicon nitride may be interposed between the semiconductor layer 102a and the gate electrode 104g. An interlayer insulating layer 105 may be disposed on the gate electrode 104g and may be formed as a single or multiple layer structure by using silicon oxide, silicon nitride, or the like. According to some embodiments, the interlayer insulating layer 105 may be formed of an organic material.

The source/drain electrodes 106s and 106d are disposed on the interlayer insulating layer 105. The source/drain electrodes 106s and 106d are electrically connected to the semiconductor layer 102a via contact holes that are formed through the interlayer insulating layer 105 and the gate insulating layer 103. The source/drain electrodes 106s and 106d may be formed as a single or multiple layer structure, by using at least one of aluminum (Al), platinum is (Pt), palladium (Pd), silver (Ag), magnesium (Mg), gold (Au), nickel (Ni), neodymium (Nd), iridium (Ir), chrome (Cr), lithium (Li), calcium (Ca), molybdenum (Mo), titanium (Ti), tungsten (W), and copper (Cu), in consideration of conductivity.

A pixel-defining layer (PDL) 109 is disposed on the source/drain electrodes 106s and 106d. The PDL 109 at least partially defines a pixel by having an opening that corresponds to each emission area EA, i.e., the opening exposes at least a center portion of a pixel electrode 111. The PDL 109 increases a distance between each end of the pixel electrode 111 and an opposite electrode 112 on the pixel electrode 111, so that the PDL 109 prevents the occurrence of an arc at each end of the pixel electrode 111. The PDL 109 may be formed of an organic material such as polyimide.

The first capacitor Cst1 is formed in the circuit area PA and includes a lower electrode 102b, an upper electrode 104b, and a dielectric layer interposed between the lower electrode 102b and the upper electrode 104b. The lower electrode 102b is formed of the same material layer as the semiconductor layer 102a of the switching transistor STR. The upper electrode 104b is formed of the same material layer as the pixel electrode 111 and the first layer L1 of the gate electrode 104g. The dielectric layer corresponds to a portion of the gate insulating layer 103. The number of electrodes that form the first capacitor Cst1, the materials that form the electrodes, and the layers whereon the electrodes are formed are not limited to the aforementioned description or what is shown in FIG. 3, and may vary.

The organic light-emitting device OLED is formed in the emission area EA and may include the pixel electrode 111, the opposite electrode 112, and an intermediate layer 113 that is interposed between the pixel electrode 111 and the opposite electrode 112. The intermediate layer 113 includes an emission layer.

The pixel electrode 111 is formed from the same material layer as the first gate electrode. Since the pixel electrode 111 is formed of the transparent conductive material, the pixel electrode 111 is formed as a transparent electrode, so that the organic light-emitting device OLED emits light toward the substrate 100.

The intermediate layer 113 of the organic light-emitting device OLED may include a small molecular weight material or a polymer material. When the intermediate layer 113 includes the small molecular weight material, the intermediate layer 113 may have a structure in which a hole injection layer (HIL), a hole transport layer (HTL), an emission layer (EML), an electron transport layer (ETL), an electron injection layer (EIL), or the like, are formed as a single or multiple layer structure, and may be formed by using one of various organic materials including copper phthalocyanine (CuPc), N,N′-Di(naphthalene-1-yl)-N,N′-diphenyl-benzidine (NPB), tris-8-hydroxyquinoline aluminum)(Alq3), or the like. The aforementioned layers may be formed by using a vacuum deposition method.

When the intermediate layer 113 includes the polymer material, the intermediate layer 113 may include the HTL and the EML. Here, the HTL may be formed of poly(3,4-ethylenedioxythiophene) (PEDOT), and the EML may be formed of poly-phenylenevinylene (PPV), polyfluorene, or the like, by using a screen printing method, an inkjet printing method, a laser induced thermal imaging (LITI), or the like. The structure of the intermediate layer 113 is not limited to the aforementioned structure and thus, may vary.

The opposite electrode 112 is disposed at an upper part of the display area DA, and in more detail, may completely cover the display area DA. The opposite electrode 112 is formed as one body with respect to a plurality of the organic light-emitting devices OLED, so that the opposite electrode 112 may correspond to a plurality of the pixel electrodes 111. The is opposite electrode 112 may be formed as a reflective electrode. When the opposite electrode 112 is formed as a reflective electrode, the opposite electrode 112 may have a layer formed of Li, Ca, LiF/Ca, LiF/Al, Al, Ag, Mg, or a compound of any of these materials. However, a structure and a material of the opposite electrode 112 may vary.

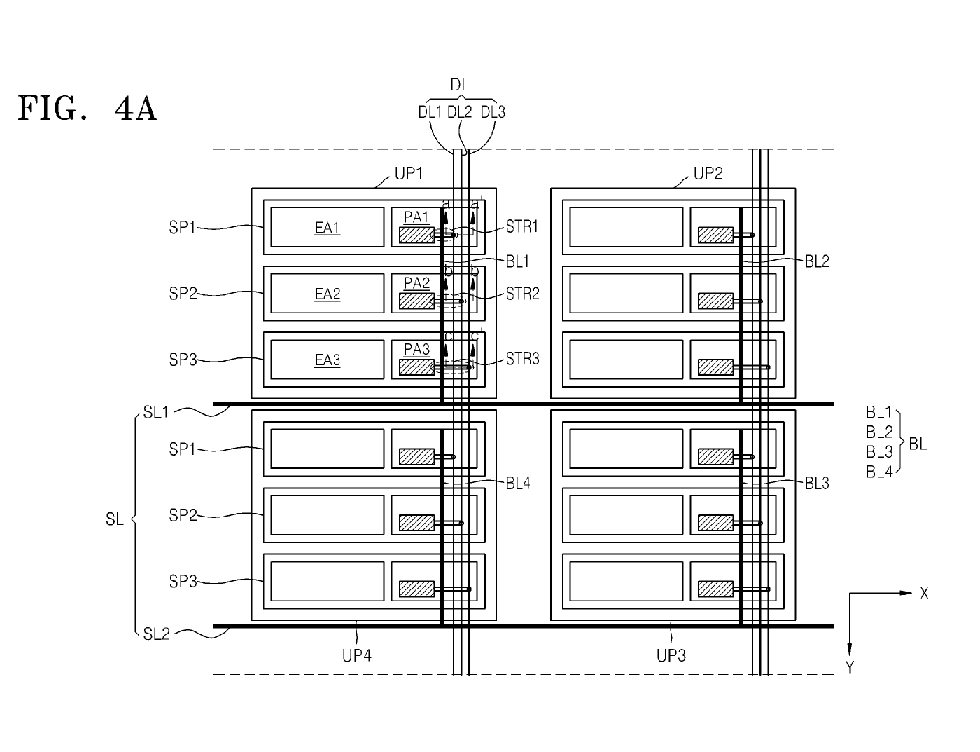

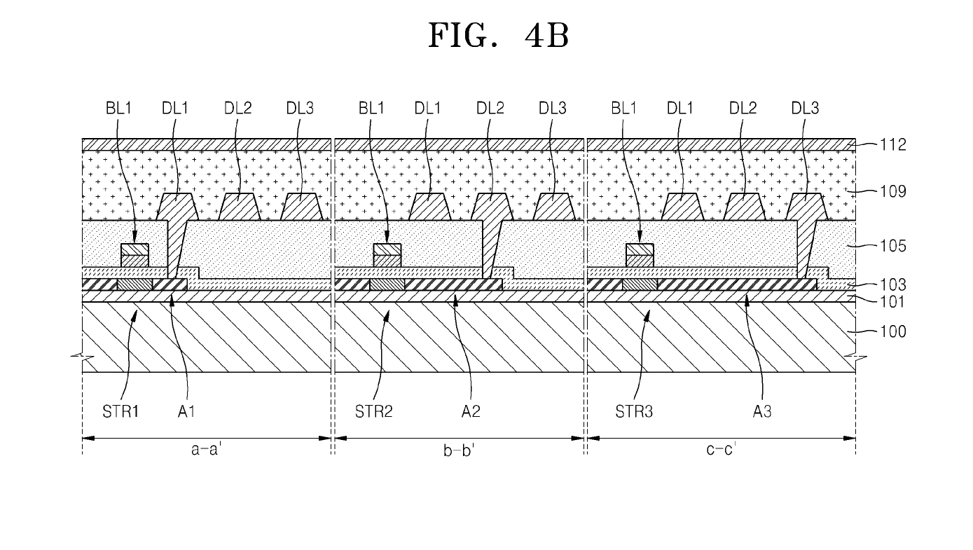

Lines that supply various electrical signals to pixels are formed in the display area DA (refer to FIG. 1). Each of a plurality of the unit pixels UP (refer to FIG. 1) is formed of a plurality of the sub-pixels SP (refer to FIG. 1), and the plurality of the unit pixels UP are arrayed in a matrix including columns and rows, in the display area DA. Along the array of the unit pixels UP, the lines extend in a first direction (an X-axis direction) or a second direction (a Y-axis direction) that crosses the first direction. As illustrated in FIGS. 2 and 4, the lines include scan lines SL1 and SL2 (refer to FIG. 4A), data lines DL1, DL2, and DL3 (refer to FIG. 4A), and the first power voltage line VDD1 (refer to FIG. 2). The scan lines SL1 and SL2, the data lines DL1, DL2, and DL3, and the first power voltage line VDD1 do not overlap with the emission area EA (refer to FIG. 1), so as not to interrupt emission of light.

FIG. 4A is a magnified view of portion IV of FIG. 1 and is a plane view of a display apparatus according to an embodiment of the present invention. Hereinafter, as shown in FIG. 1: a unit pixel UP refers to a general unit pixel used to describe the features of various specific unit pixels; a sub-pixel SP refers to a general sub-pixel used to describe the features of various specific sub-pixels; an emission area EA refers to a general emission area used to describe the features of various specific emission areas; and a collective circuit area PA refers to a general collective circuit area used to describe the features of various specific collective circuit areas. Also, switching transistor STR refers to a general switching transistor. For convenience of description, a scan line SL refers to a general scan line, a data line group DL refers to a is general group of data lines, and a branch line BL refers to a general branch line.

Referring to FIG. 4A, four unit pixels UP are matrix-arrayed, and in a clockwise direction, the four unit pixels UP are a first unit pixel UP1, a second unit pixel UP2, a third unit pixel UP3, and a fourth unit pixel UP4. Each of the four unit pixels UP includes sub-pixels SP that emit light of different colors, which are arranged in a second direction (a Y-axis direction). Along the second direction, the sub-pixels SP are referred to as a first sub-pixel SP1, a second sub-pixel SP2, and a third sub-pixel SP3. Each of the sub-pixels SP includes an emission area EA and a circuit area PA, and in this regard, the emission areas EA are referred to as first, second, and third emission areas EA1, EA2, and EA3, and the circuit areas PA are referred to as first, second, and third circuit areas PA1, PA2, and PA3.

The data line group DL transfers a data signal to a sub-pixel SP and extends in the second direction. In one unit pixel UP, the number of data lines in the data line group DL corresponds to the number of sub-pixels SP that are included in the unit pixel UP, so that the data lines of the data line group DL are independently connected to the sub-pixels SP. For example, referring to FIG. 4A, three sub-pixels SP are arranged per one unit pixel UP. Thus, three data lines are included in the data line group DL. In more detail, a first data line DL1 is connected to a first sub-pixel SP1, a second data line DL2 is connected to a second sub-pixel SP2, and a third data line DL3 is connected to a third sub-pixel SP3.

The three sub-pixels SP that are included in one unit pixel UP may receive different data signals. Sub-pixels SP that emit light of the same color and that are from among sub-pixels SP included in unit pixels UP that are disposed in the same column may be commonly connected to a data line of one data line group DL. That is, the sub-pixels SP that are disposed in the same column and that emit light of the same color may receive the same data signal. For is example, the first sub-pixel SP1 of the first unit pixel UP1, and the first sub-pixel SP1 of the fourth unit pixel UP4 are both connected to the first data line DL1, thereby receiving the same data signal. The first, second, and third data lines DL1, DL2, and DL3 are disposed together. By doing so, the display apparatus may have an aperture ratio that is higher than a case in which the first, second, and third data lines DL1, DL2, and DL3 are not disposed together.

A length of the data line group DL is shorter than a length of a scan line SL to be described later. For example, a length of each of the first, second, and third data lines DL1, DL2, and DL3 is shorter than a length of each of first and second scan lines SL1 and SL2. As the length of the data line group DL is increased, the strength of a data signal that is input to a sub-pixel SP is reduced by line resistance, due to the length of the data line group DL. In general, the display apparatus is more affected by a data signal than a scan signal. In order to make the length of the data line group DL shorter than the length of the scan line SL, as illustrated in FIG. 1, the emission areas EA of the pixels are disposed lengthwise along the first direction (the X-axis direction), which is a long axis of the display apparatus, so that imbalance between data signals that are input to the display apparatus may be prevented.

Although not illustrated in FIG. 4A, the first power voltage lines VDD1 (refer to FIG. 2) extend in the second direction (the Y-axis direction) in the same manner as the data line DL, and one first power voltage line VDD1 corresponds to one unit pixel UP. In this regard, sub-pixels SP that form the unit pixel UP are connected to the same first power voltage line VDD1. Since the first power voltage line VDD1 extends in the second direction (the Y-axis direction), the unit pixels UP that are disposed in the same column may be connected to the same first power voltage line VDD1. The first power voltage line VDD1 may be disposed adjacent to the data line DL. In other words, referring to FIG. 4A, the first power voltage line VDD1 may is be disposed at a right side of the third data line DL3. However, a position of the first power voltage line VDD1 may vary.

The scan lines SL that transfer a scan signal extend in the first direction (the X-axis direction), and one scan line SL corresponds to one unit pixel UP. Also, the unit pixels UP that are disposed in the same row may commonly correspond to one scan line SL. In other words, a first scan line SL1 corresponds to the first unit pixel UP1 and the second unit pixel UP2, and a second scan line SL2 corresponds to the third pixel unit UP3 and the fourth pixel unit UP4, but not the first unit pixel UP1 and the second unit pixel UP2. That is, the first scan line SL1 is connected to the first unit pixel UP1 and the second unit pixel UP2 that are disposed in the same row. Similarly, the second scan line SL2 is connected to the third pixel unit UP3 and the fourth pixel unit UP4 that are disposed in the same row.

According to the related art, scan lines correspond to a total number of sub-pixels, and are independently connected to the sub-pixels. However, since all of sub-pixels that form one unit pixel receive the same scan signal, if one scan line corresponds to one unit pixel, the display apparatus may normally operate. Thus, the number of wirings may be decreased by disposing one scan line that corresponds to one unit pixel, and not by disposing scan lines that correspond in number to the number of sub-pixels forming one unit pixel. As the number of wirings is decreased, an aperture ratio of the display apparatus may be increased, occurrence of open and short errors may be decreased due to simplification of a wiring arrangement, and when an open or short occurs at a scan line, a position of the error occurrence may be easily checked.

When one scan line SL is connected one unit pixel UP, a branch line BL is arranged to apply a scan signal to each of the sub-pixels SP that form the unit pixel UP. The branch line BL extends from the scan line SL in a second direction (a Y-axis direction). One is branch line BL is connected to one unit pixel UP. In other words, the branch line BL does not commonly correspond to unit pixels UP that are disposed in the same row or column, as a scan line SL or a data line group DL does. Instead, the branch line BL is connected to only one unit pixel UP. For example, a first branch line BL1 is connected to only the first unit pixel UP1. Second, third, and fourth branch lines BL2, BL3, and BL4 are independently connected to only the second, third, and fourth unit pixels UP2, UP3, and UP4, respectively. Although other configurations are possible, the branch line BL and the scan line SL may be simultaneously formed of the same material layer as each other.

Referring to FIG. 4A, with respect to a unit pixel UP, the scan line SL may be disposed a side edge that extends in a first direction (an X-axis direction) and that is disposed at a side edge of the unit pixel UP. In other words, with respect to a plurality of the unit pixels UP, the scan line SL is disposed to cross a space between two unit pixels UP that are adjacent to each other in a column direction. For example, the first scan line SL1 may be disposed to cross a space between the first unit pixel UP1 and the fourth unit pixel UP4.

The branch line group BL extends from the scan line SL toward the unit pixel UP that corresponds to the scan line SL. The branch line group BL is electrically connected to each of a plurality of sub-pixels SP forming the corresponding unit pixel UP that corresponds to the scan line SL. For example, the first branch line BL1 is connected to each of the first, second, and third sub-pixels SP1, SP2, and SP3 that form the first unit pixel UP1. In more detail, the first branch line BL1 forms each of gate electrodes of first, second, and third switching transistors STR1, STR2, and STR3 that are disposed in circuit areas PA1, PA2, and PA3 of the first, second, and third sub-pixels SP1, SP2, and SP3, so that the first branch line BL1 is electrically connected to each of the first, second, and third sub-pixels SP1, SP2, and SP3.

FIG. 4B illustrates a cross-section of the display apparatus, taken along lines a-a′, b-b′, and c-c′ of FIG. 4A. Referring to FIG. 4B, the first switching transistor STR1 includes a first gate electrode formed of a first active layer A1 and a first branch line BL1, a first source electrode connected to a first data line DL1, and a first drain electrode connected to a first circuit area PA1 (not shown). Similarly, the second switching transistor STR2 includes a second gate electrode formed of a second active layer A2 and the first branch line BL1, a second source electrode connected to a second data line DL2, and a second drain electrode connected to a second circuit area PA2 (not shown). Also, similarly, the third switching transistor STR3 includes a third gate electrode formed of a third active layer A3 and the first branch line BL1, a third source electrode connected to a third data line DL3, and a third drain electrode connected to a third circuit area PA3 (not shown).

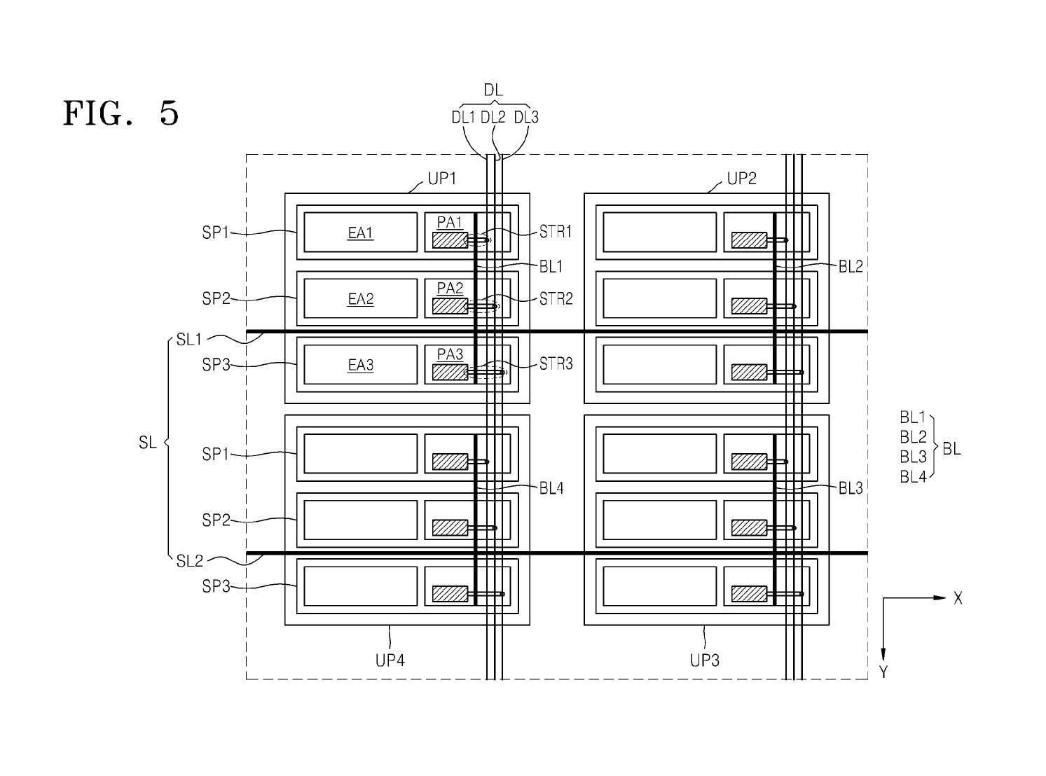

FIG. 5 is a magnified view of portion IV of FIG. 1 and is a plane view of a display apparatus according to another embodiment of the present invention. The embodiment of FIG. 5 is different from the embodiment of FIG. 4A in terms of the position of a scan line SL.

Referring to FIG. 5, with respect to a unit pixel UP, the scan line SL is disposed to cross a space between two sub-pixels SP that are adjacent to each other and that are from among sub-pixels SP forming the unit pixel UP. For example, a first scan line SL1 may cross a space between a second sub-pixel SP2 and a third sub-pixel SP3 of a first unit pixel UP1.

A branch line BL extends from the scan line SL in a direction of sub-pixels SP forming the unit pixel UP that corresponds to the scan line SL. The branch line BL may extend from two opposing sides of the scan line SL in the Y-axis direction, i.e., in both a positive Y-axis direction and a negative Y-axis direction. For example, a first branch line BL1 extends from the scan line SL in a direction toward a first sub-pixel SP1 and a second sub-pixel SP2, and extends is toward a third sub-pixel SP3, so that the first branch line BL1 is connected to each of the first, second, and third sub-pixels SP1, SP2, and SP3. In more detail, the first branch line BL1 forms each of gate electrodes of first, second, and third switching transistors STR1, STR2, and STR3 that are disposed in circuit areas PA1, PA2, and PA3 of the first, second, and third sub-pixels SP1, SP2, and SP3, so that the first branch line BL1 is electrically connected to each of the first, second, and third sub-pixels SP1, SP2, and SP3.

Compared to the embodiment of FIG. 4A, in the embodiment of FIG. 5, a the distance the branch line BL extends from the scan line SL may be decreased, and the branch line BL is connected to the scan line SL close to the center of the branch line BL, so that a voltage drop due to a line length at an end of the branch line BL may be decreased.

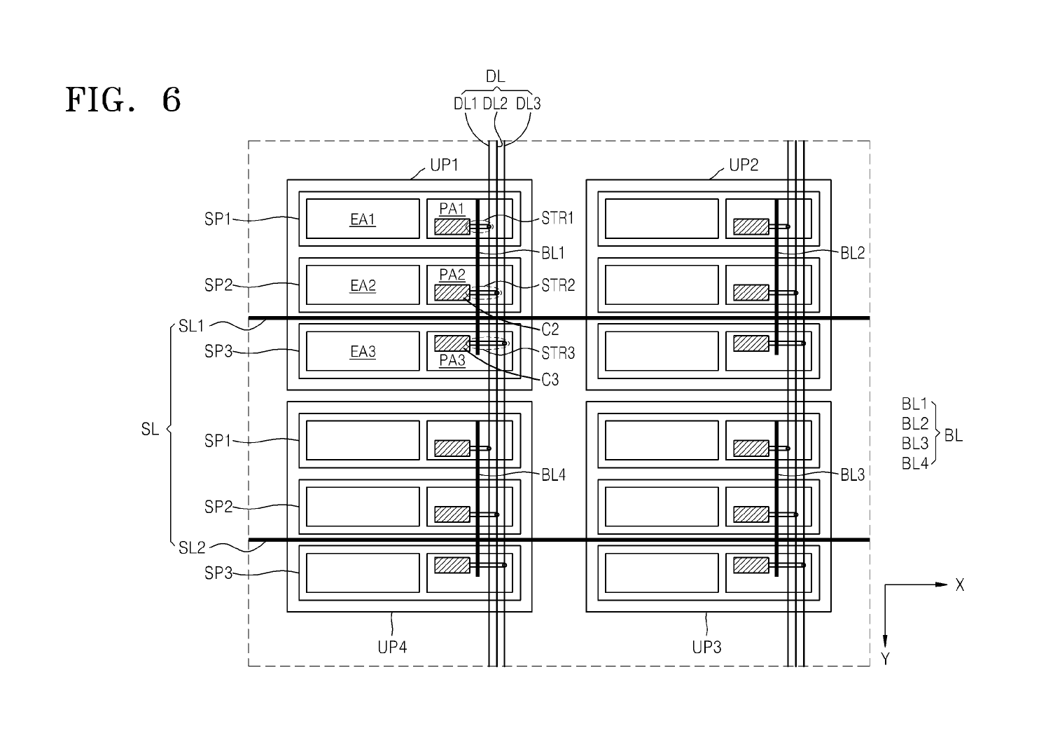

FIG. 6 is a magnified view of portion IV of FIG. 1 and is a plane view of a display apparatus according to another embodiment of the present invention. The embodiment of FIG. 6 is different from the embodiment of FIG. 5, in a structure of sub-pixels SP that are disposed at sides of a scan line SL.

Referring to FIG. 6, switching transistors STR that are included in two sub-pixels SP are disposed to be symmetrical to each other with respect to the scan line SL, wherein the two sub-pixels SP are adjacent to each other and are disposed at opposite sides of the scan line SL. For example, a second sub-pixel SP2 and a third sub-pixel SP3 are disposed at positions at which a second switching transistor STR2 and a third switching transistor STR3 are symmetrical to each other with respect to the scan line SL. Obviously, the second sub-pixel SP2 and the third sub-pixel SP3 may be disposed at positions at which, in addition to the second and third switching transistors STR2 and STR3, second and third circuit units C2 and C3 that are included in second and third circuit areas PA2 and PA2, i.e., a plurality of transistors and at least one is capacitor are symmetrical to each other with respect to the scan line SL.

Compared to the embodiment of FIG. 5, in the embodiment of FIG. 6, switching transistors STR may be disposed closer to the adjacent to the scan line SL, so that a length of a branch line BL may be further decreased. By doing so, a voltage drop due to a line length at an end of the branch line BL may be smaller than in the embodiment of FIG. 5.

Although the embodiments of FIGS. 5 and 6 show the scan lines SL1 and SL2 disposed between the second and third sub-pixels SP2 and SP3 of the unit pixels UP, the scan lines SL1 and SL2 may alternatively be disposed between the first and second sub-pixels SP1 and SP2 of the unit pixels UP. In this case, the first and second sub-pixels SP1 and SP2 may have symmetrical dispositions of elements, similar to that described above with regard to the second and third sub-pixels SP2 and SP3 of FIG. 6.

According to the one or more embodiments of the present invention, it is possible to provide the display apparatus in which the number of scan lines is decreased so that an aperture ratio of the display apparatus is improved and the defect rate of wiring is decreased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus comprising:
a unit pixel comprising sub-pixels, each sub-pixel comprising an emission area and a circuit area, the emission area comprising a light emitting element and the circuit area comprising a switching transistor configured to control the light emitting element;
a scan line extending in a first direction;
a branch line extending from the scan line in a second direction crossing the first direction, the branch line being connected to the sub-pixels; and
data lines extending in the second direction and respectively connected to the sub-pixels.

2. The display apparatus of claim 1, wherein the scan line is disposed at an edge of the unit pixel that extends in the first direction.

3. The display apparatus of claim 2, wherein the branch line forms gate electrodes of switching transistors of the sub-pixels.

4. The display apparatus of claim 1, wherein the scan line extends between two adjacent ones of the sub-pixels.

5. The display apparatus of claim 4, wherein the branch line forms gate electrodes of switching transistors of the sub-pixels.

6. The display apparatus of claim 4, wherein:
switching transistors that are comprised in the two adjacent sub-pixels are each disposed closer to an edge of the circuit area that is adjacent to the scan line than to an opposing edge of the circuit area; and
the two adjacent sub-pixels are disposed at opposite sides of the scan line.

7. The display apparatus of claim 4, wherein switching transistors that are comprised in the two adjacent sub-pixels are disposed different distances from the scan line.

8. The display apparatus of claim 1, wherein the scan line and the branch line are formed on the same layer.

9. The display apparatus of claim 1, wherein each of the sub-pixels emits light of a different color.

10. The display apparatus of claim 9, wherein the data lines and the branch line all extend across the same side of the unit pixel.

11. The display apparatus of claim 9, wherein the scan lines extend along the length of the display apparatus and the data lines extend along the width of the display apparatus.

12. The display apparatus of claim 1, wherein the data lines are each shorter than the scan line.

13. The display apparatus of claim 1, wherein each light emitting unit comprises an organic light-emitting device comprising a first electrode, a second electrode, and an organic emission layer disposed between the first electrode and the second electrode.

14. The display apparatus of claim 1, wherein the scan line, the branch line, and the data lines do not overlap the emission areas.

15. The display apparatus of claim 1, wherein the circuit area of each of the sub-pixels comprises another transistor and at least one capacitor.

16. The display apparatus of claim 1, further comprising a power supply line that extends in the second direction and that is connected to each of the sub-pixels.

17. The display apparatus of claim 1, the unit pixel comprises only three of the sub-pixels.

18. The display apparatus of claim 1, further comprising a plurality of the unit pixels disposed in rows and columns of a matrix, wherein,
the scan line is commonly connected to the unit pixels of one of the rows,
the data lines are connected to unit pixels that are disposed in one of the columns, and
the branch line is connected to only one of the unit pixels.

19. The display apparatus of claim 18, wherein the number of the data lines disposed in one of the columns is equal to the number of sub-pixels in each of the unit pixels disposed in the column.

20. The display apparatus of claim 1, wherein:
the scan line extends between two adjacent ones of the sub-pixels; and
the branch line extends from opposing sides of the scan line, so as to be connected to the adjacent sub-pixels.
